(19) United States
(12) Patent Application Publication
(10) Pub. No.: US 2008/0182130 A1
(43) Pub. Date: Jul. 31, 2008

(54) Magnet structure with colorable surface and a method for manufacturing the magnet

(76) Inventors: Hung-Chih Wu, Taipei County (TW); Chen-Liang Fan Chiang, Taipei County (TW); Yi-Ju Wu, Taipei County (TW)

Correspondence Address: BACON & THOMAS, PLLC, 625 SLATERS LANE, FOURTH FLOOR, ALEXANDRIA, VA, 22314, US

(21) Appl. No.: 11/984,346

(22) Filed: Nov. 16, 2007

(30) Foreign Application Priority Data
Jan. 26, 2007 (TW) 096103110
Apr. 27, 2007 (TW) 096115200

(51) Int. Cl. B32B 25/04; B05D 1/02

(52) U.S. Cl. 428/704; 427/290; 427/427.4

(57) ABSTRACT

A magnet structure with colorable surface and a method for manufacturing the magnet structure. The method includes a step of disposing a colorable facial layer on a surface of the magnet. The material of the colorable facial layer is a mixture of polymer resin, good ink-absorbing material and tackifier, whereby the colorable facial layer has high adhesion to the surface of the magnet. In addition, the colorable facial layer can easily absorb an ink or a color so that the colorable facial layer can be further colored or printed with a figure.

### BACKGROUND OF THE INVENTION

The present invention is related to a magnet structure with colorable surface and a method for manufacturing the magnet structure. The method includes a step of disposing a colorable facial layer on a surface of the magnet. The colorable facial layer has high adhesion to the magnet as well as ink or color. Therefore, the colorable facial layer is uneasy to peel off from the magnet and can be further colored or printed with a figure.

Generally, a common magnet is made in such a manner that ferric oxide powder is added into a complex material which is a mixture of rubber and plastic. The material is at least once magnetized to induce magnetic poles on the material. Accordingly, a flexible magnet is formed which is able to attract an iron-made object.

It often takes place that in use of the conventional rubber magnet, the magnetic powder (ferric oxide powder) detaches from the magnet to stain a user's hands. In case the user fails to wash off the magnetic powder and incautiously eats the magnetic powder or contacts with the magnetic powder at some sensitive parts (such as eyes), the user may get hurt.

In order to obviate this problem, in prior art as shown in FIGS. 1 and 2, a layer of polishing oil or paint 61 is sprayed or printed by means of halftone or phototype on the surface of the rubber magnet to isolate the magnetic powder from outer side. However, the performances of the common paint are quite different from the performances of the surface of the rubber magnet. Therefore, the paint layer on the folding portion of the magnet tends to crack or peel off. This leads to a poor appearance of the magnet. In addition, the peeling paint often contaminates the environment and a user's hands.

On the other hand, the surface of the conventional rubber magnet has a black/brown color due to ferric oxide composition. Typically, a color or paint is printed or sprayed on the surface of the magnet to change the color of the surface of the rubber magnet. However, the particle structure of the rubber magnet (ferric oxide) is quite different from that of the common paint. Therefore, it is hard for the color (paint) to directly attach to the magnet. Moreover, even if the color is successfully sprayed on the surface of the magnet, the color (paint) is apt to crack or peel off in later use, especially from the flexible magnetic file clip, decorative sheet, magnetic bookmark, etc. due to poor adhesion. In use of such magnet with the isolating layer or color layer of poor adhesion, the peeling paint or magnetic powder obviously will lead to problem of contamination. Furthermore, when it is desired to form a picture on the surface of the magnet, due to the limitation of color saturation, only simple picture can be formed on the surface of the magnet. This narrows the application range of the magnet. Therefore, it is desperately tried by the manufacturers to stably color the surface of the magnet and enhance the adhesion of the color (paint) to the magnet.

Referring to FIG. 3, it was tried by some manufacturers to adhere a paper, PP synthetic paper, PVC or PET facial layer 62 onto the surface of the rubber magnet 60 as an isolating layer. The facial layer 62 is colored or formed with a picture. However, such facial layer is easy to crimp or peel off from the surface of the magnet. This results in a poor appearance of the magnet. Moreover, the facial layer 62 is printed with the picture by means of a printer. Due to the limitation of the cost for the plate, there is a minimum amount of the prints. Therefore, such measure is inapplicable to those fields only requiring few prints.

None of the existent magnets can be directly colored or printed to form a picture on the surface. Some manufacturers produce a kind of magnet to the surface of which a medium material is previously adhered. The medium material can be a paper, a composite facial layer or a fabric. The surface of the medium material is then colored or printed to achieve a saturated colorful effect. However, the facial layer is still apt to peel off, crack or crimp.

Recently, some manufacturers have tried to paint mixed colors (paints) on the surface of the magnet 60 (as shown in FIG. 4.) This improves the shortcoming of peeling or cracking of the color layer. However, it is impossible to further color or print any picture on the color layer.

It is therefore tried by the applicant to reconsider the texture of the magnet and provide a magnet having a colorable facial layer. The colorable facial layer is bonded with the surface of the magnet at high adhesion. In addition, an ink or color can adhere to the colorable facial layer at high adhesion. Therefore, it is easy to further color or print a picture on the colorable facial layer and the facial layer is hard to crack or peel off from the surface of the magnet.

### SUMMARY OF THE INVENTION

It is therefore a primary object of the present invention to provide a magnet structure with colorable surface and a method for manufacturing the magnet structure. The method includes a step of disposing a colorable facial layer on a surface of the magnet. The performances of the colorable facial layer are close to those of the magnet as well as ink or color so that the colorable facial layer has high adhesion to the magnet and the ink or color. Therefore, the colorable facial layer is uneasy to peel off from the magnet and can be further colored or printed with a figure to beautify the appearance of the magnet.

According to the above object, the method for manufacturing the magnet structure of the present invention includes a step of painting or spraying a colorable facial layer on a surface of the magnet. The material of the colorable facial layer is a mixture of polymer resin, good ink-absorbing material and tackifier, whereby the colorable facial layer has high adhesion to the surface of the magnet and is uneasy to peel off from the magnet. In addition, the colorable facial layer can easily absorb an ink or a color so that the colorable facial layer can be further colored or printed with a figure.

In case of thin magnet, a face (such as back face) of the magnet free from the colorable facial layer is coated with an adhesive layer. Therefore, the magnet can be adhered to an article for easy use. Moreover, the thin magnet with the back adhesive can be cut into elongated tapes to form tape-like magnets for wider application range. In addition, the tape-like magnet can be formed with tearing stripe structures continuously arranged in the same direction. The tearing stripe structures can be grooves, dotted lines or strings of orifices. Accordingly, a user can tear off a segment of the tape-shaped magnet along one of the tearing stripe structures.

The tape-shaped magnet can be wound on a reel as a reel of adhesive tape.

The present invention can be best understood through the following description and accompanying drawings wherein:

### BRIEF DESCRIPTION OF THE DRAWINGS

FIG. 1 is a view showing that a layer of polishing oil or color (paint) is sprayed onto the surface of a magnet in a conventional manner;

FIG. 2 is a view showing that a layer of polishing oil or color (paint) is printed onto the surface of a magnet by means of halftone or phototypography;

FIG. 3 shows that a colored facial layer is adhered to the surface of a magnet in a conventional manner;

FIG. 4 shows that mixed colors (paints) are painted onto the surface of the magnet to form a UV plastic coating;

FIG. 5 is a flow chart of the manufacturing method of the present invention;

FIG. 6A shows that the colorable layer material is sprayed onto the surface of the magnet to form a colorable facial layer on the magnet of the present invention;

FIG. 6B shows that the colorable layer material is painted onto the surface of the magnet to form a colorable facial layer on the magnet of the present invention;

FIG. 7 shows that the magnet of the present invention is printed with a figure by means of a printer;

FIG. 8 is an enlarged view of circled area A of FIG. 7;

FIG. 9 shows that the magnet of the present invention is colored or printed with a figure by means of transfer printing;

FIG. 10 shows that an adhesive is painted on a back face of the thin magnet of the present invention;

FIG. 11 is a view according to FIG. 10, in which the thin magnet is formed with tearing stripe structures which are fine grooves;

FIG. 12 shows that the thin magnet of the present invention is cut into several elongated tapes by means of a cutting machine;

FIG. 13 shows that the tape-shaped magnet of FIG. 12 is wound into a reel of magnetic tape;

FIG. 14 shows that a segment of the magnetic tape is torn off along the tearing stripe structure;

FIG. 15 shows that the tearing stripe structures of the magnetic tape are linear dotted lines or strings of linearly arranged orifices; and

FIG. 15A is an enlarged view of circled area A of FIG. 15.

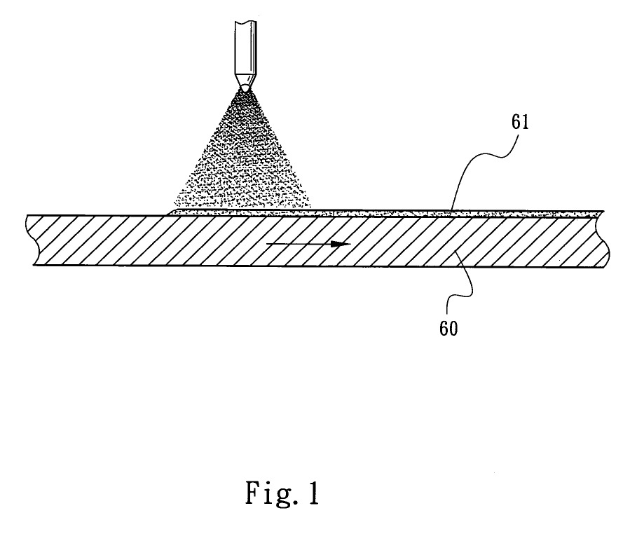

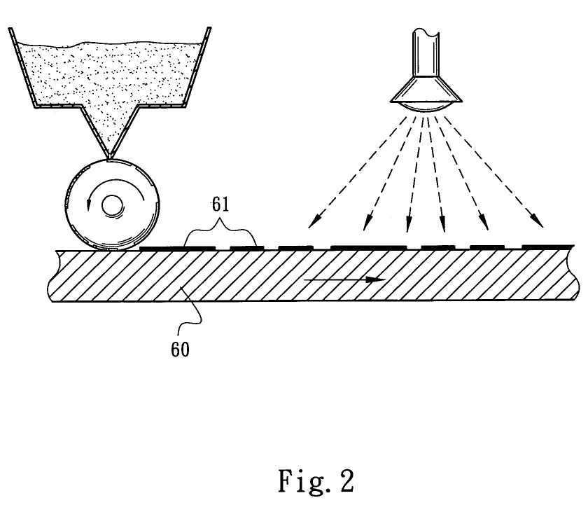

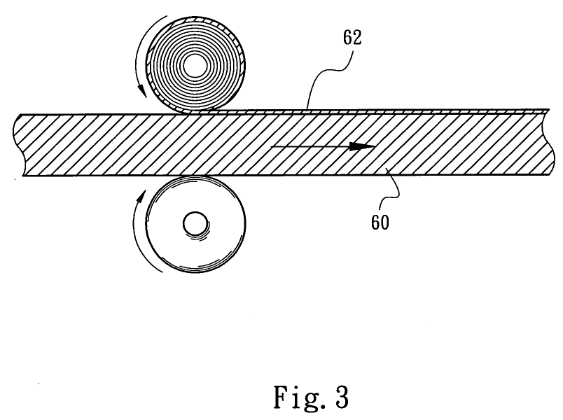

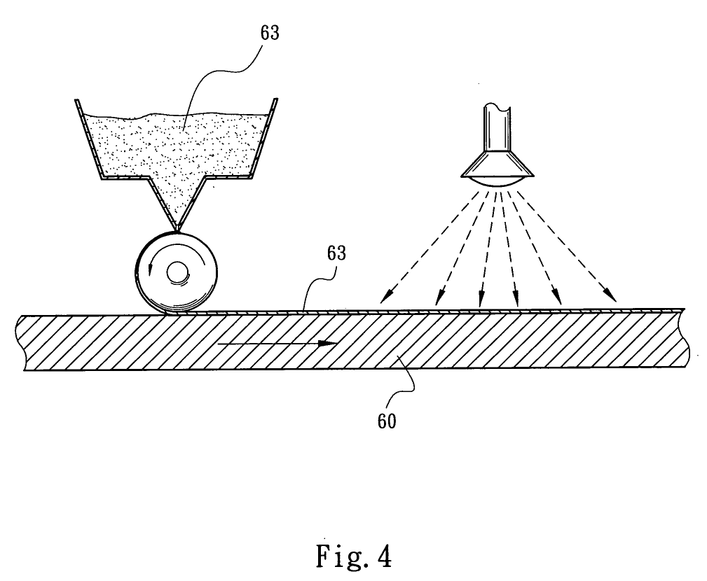

### DETAILED DESCRIPTION OF THE PREFERRED EMBODIMENTS

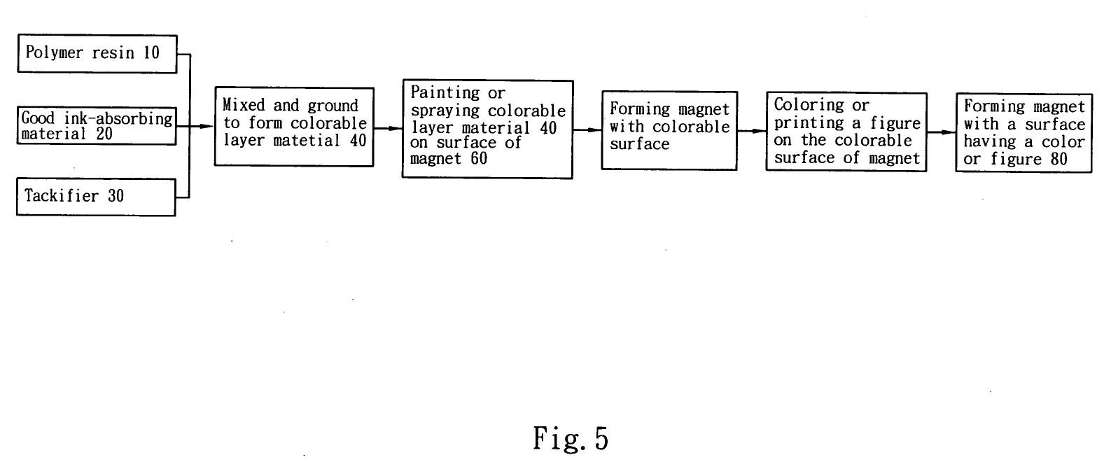

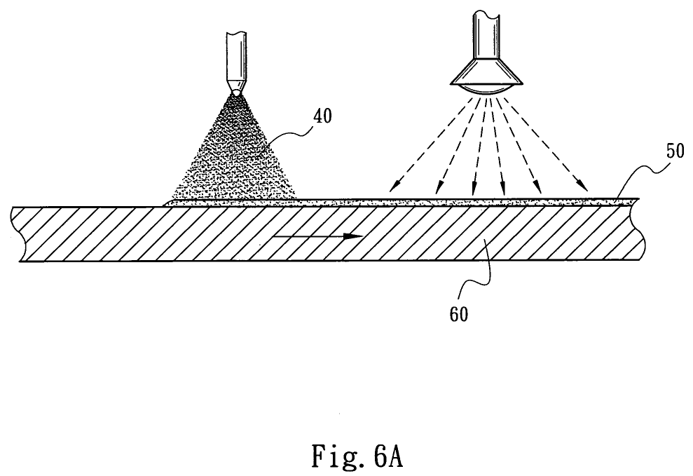

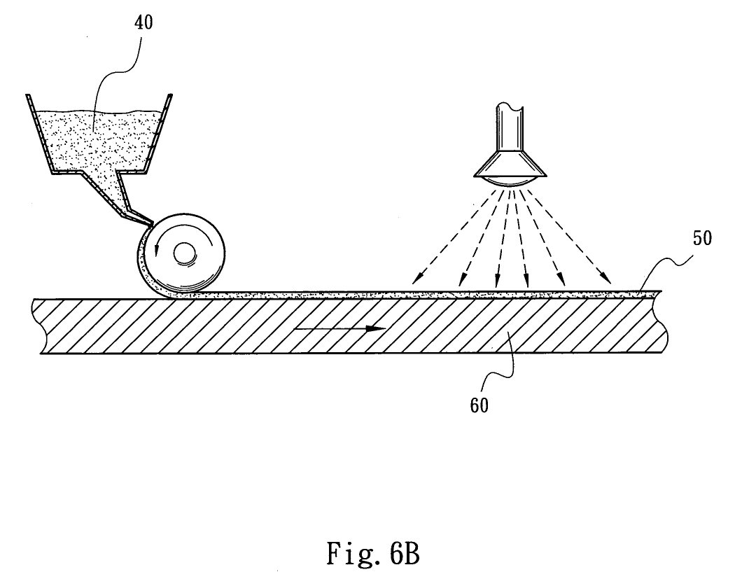

Please refer to FIGS. 5, 6A and 6B. The magnet of the present invention has a colorable facial layer 50 made of a colorable layer material 40. The colorable layer material 40 is a mixture of a certain amount of polymer resin 10, good ink-absorbing material 20 and tackifier 30. These compositions are mixed and ground to form the colorable layer material 40. A humidity spreader can be further added into the mixture as necessary. The polymer resin 10 is a synthetic resin having high adhesion to the magnet 60, especially the rubber magnet. The good ink-absorbing material 20 is one of titanium dioxide, lithopone and calcium carbonate or a composition thereof. The tackifier 30 can be aminosilane. The humidity spreader can be polyaminocarboxylate. The magnet 60 is made of a magnetizable material such as barium, strontium, rubidium, cobalt, boron, iron, ferric oxide, etc. or is made of a composition thereof. A rubber complex material can be added into the material to form a rubber magnet material.

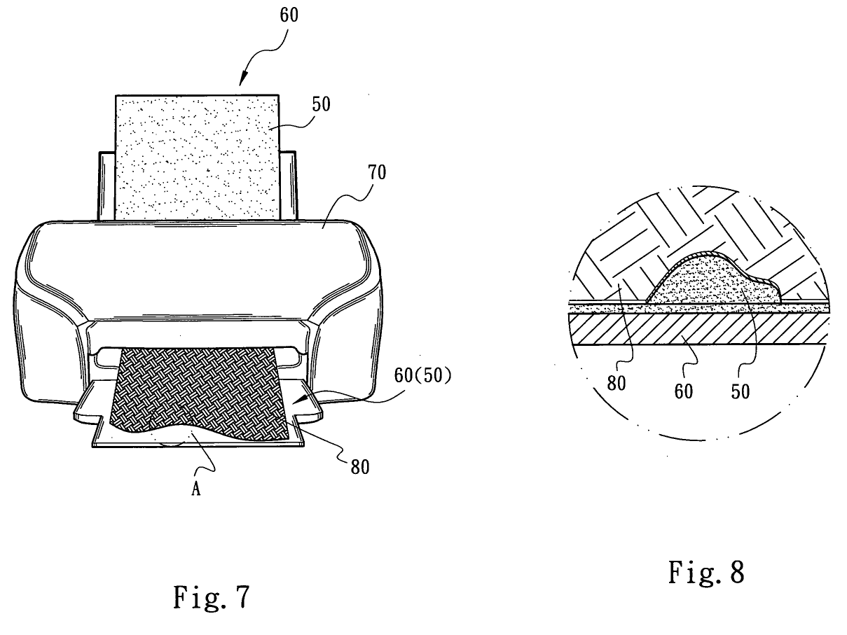

The above colorable layer material 40 has a very good adhesion to the surface of the magnet 60. A painting machine (as shown in FIG. 6B) or a sprayer (as shown in FIG. 6A) is used to paint or spray a layer of material 40 onto the surface of the magnet 60. Then, through a drying procedure by a drier or a chemical bridging effect, the material 40 is solidified to form a uniform colorable facial layer 50 on the surface of the magnet 60. The colorable facial layer 50 has very high adhesion to the surface of the magnet 60 so that the colorable facial layer 50 is not easy to peel off or crack. In addition, the colorable facial layer 50 has a very high surface uniformity so that the colorable facial layer 50 can absorb an ink or a color (paint) very well to be colored. Accordingly, as shown in FIGS. 7 and 8, the colorable facial layer 50 can be easily further printed or colored. A printer 70 or a computer drafter can be used to directly print a fine colorful FIG. 80 on the colorable facial layer 50.

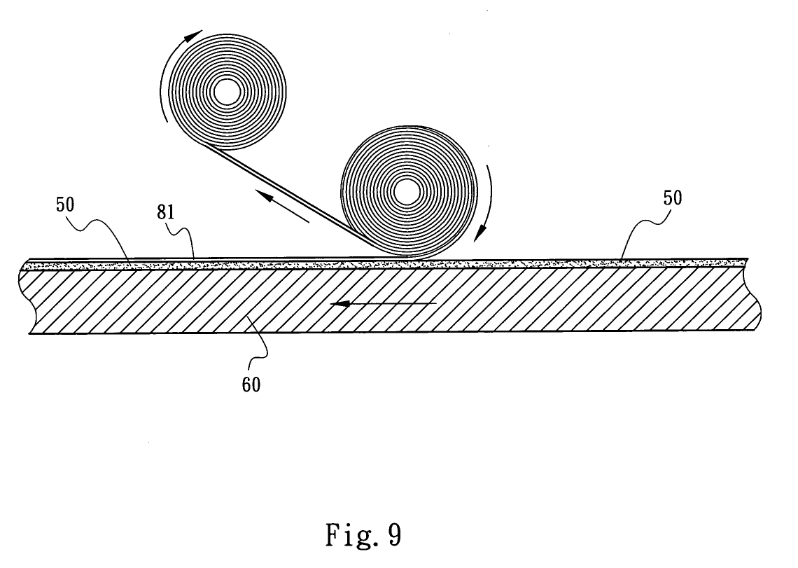

The colorable facial layer 50 not only can be directly printed with a figure or colored by means of a computer drafter or a printer, but also can be printed with a figure or a color layer 81 by way of transfer printing as shown in FIG. 9. The colorable facial layer 50 can be fully or partially disposed on single face of a sheet of magnet 60 or on both faces thereof to serve as a protective layer and achieve a setoff effect.

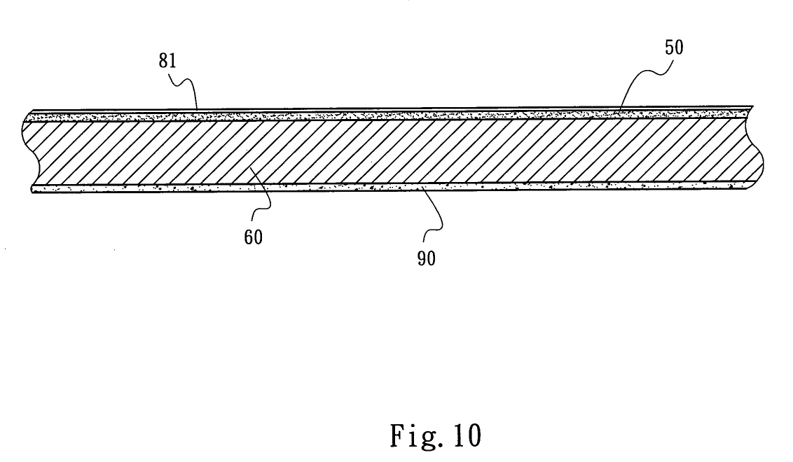

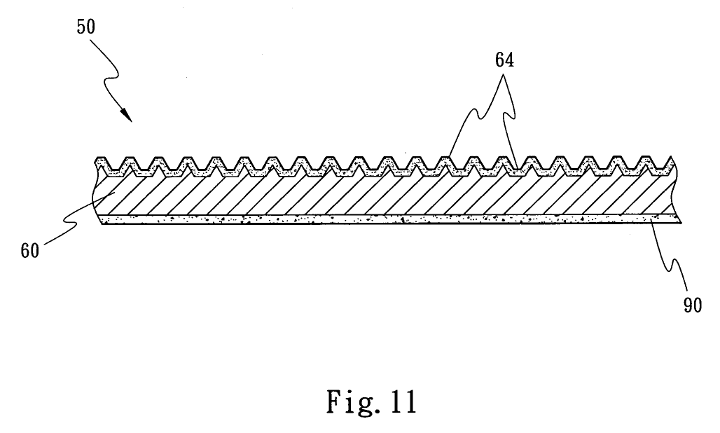

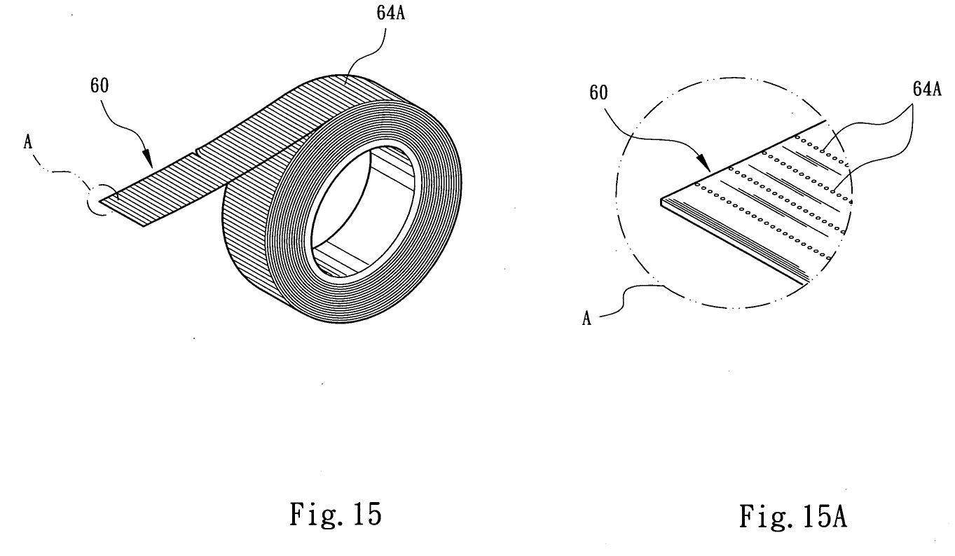

Referring to FIG. 10, the face of the magnet 60 free from the colorable facial layer 50 can be coated with an adhesive layer 90, whereby this face can adhere to an article. In addition, as shown in FIG. 11, the magnet 60 is formed with tearing stripe structures 64 continuously arranged in the same direction. The tearing stripes 64 can be arranged at equal intervals or unequal intervals according to the distance between the magnetic poles. The tearing stripe structures 64 can be grooves with a certain depth. With the colorable facial layer 50 or color layer 81 facing outward and the adhesive layer 90 facing inward, the magnet 60 can be wound up. As shown in FIG. 11, the tearing stripe structures 64 can be linear fine grooves. Alternatively, the tearing stripe structures 64 can be linear dotted lines (as shown in FIG. 15) or strings of linearly arranged orifices 64A (as shown in FIG. 15A).

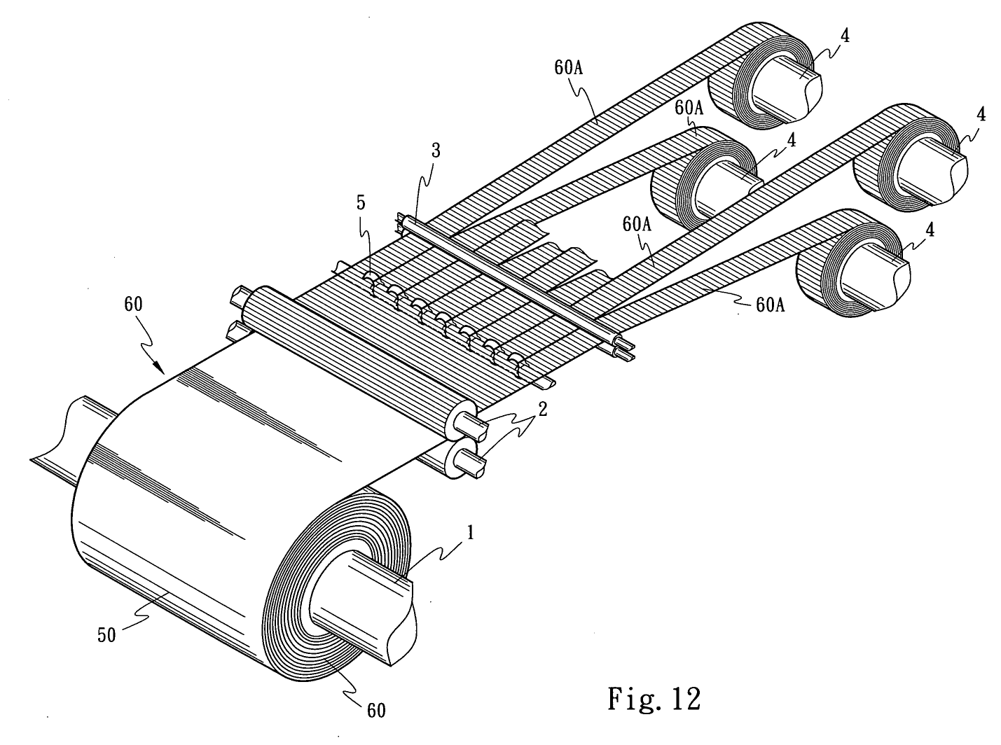

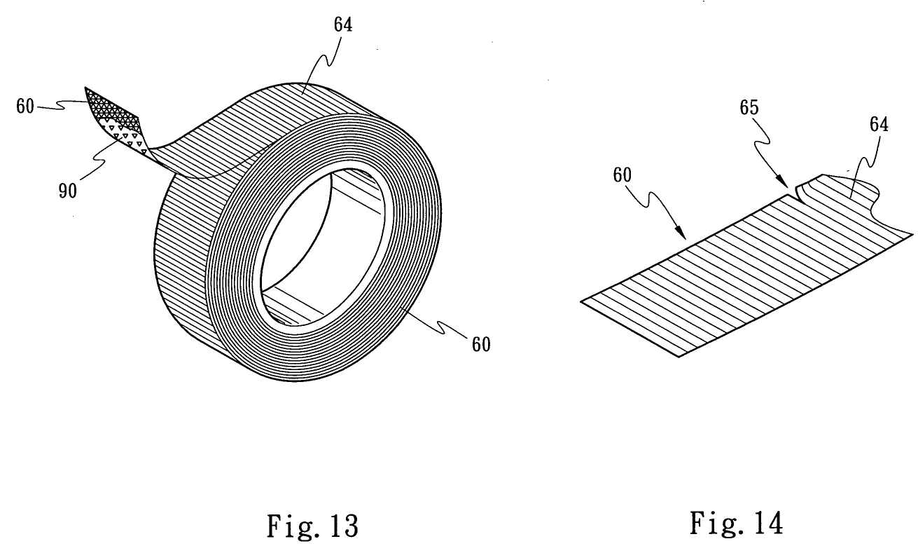

FIG. 12 shows an automatic cutting machine for cutting and winding the magnet. The automatic cut t ing machine includes multiple roller units 1, 2, 3 and 4 and a cutter assembly 5. The original magnet 60 having the tearing stripe structures 64 or free from the tearing stripe structures 64 is wound around the main roller unit 1. The original magnet 60 is drawn out by dual-pressure rollers 2, 3 to be cut by the cutter assembly 5 into multiple tapes. The tapes are respectively wound around the subsidiary roller units 4 to form several reels of tape-shaped magnets as shown in FIG. 13.

Referring to FIG. 14, a user can manually apply a shear force to the magnetic tape with the tearing stripe structures 64 to tear off a segment along one of the tearing stripe structures 64.

In conclusion, the magnet with colorable surface of the present invention is free from all the problems existing in the conventional magnets. In addition, the manufacturing method for the magnet with the colorable surface of the present invention provides an advanced measure for making magnets including rubber magnets and soft/hard magnets.

The above embodiments are only used to illustrate the present invention, not intended to limit the scope thereof. Many modifications of the above embodiments can be made without departing from the spirit of the present invention.

What is claimed is:

1. A method for manufacturing a magnet with colorable surface, comprising a step of disposing a colorable facial layer on at least one surface of the magnet, the colorable facial layer having very high adhesion to the surface of the magnet, the colorable facial layer being characterized in that the colorable facial layer can easily absorb an ink or a color so that the colorable facial layer can be further colored or printed with a figure.

2. The method for manufacturing the magnet with colorable surface as claimed in claim 1, wherein the magnet is a soft magnet.

3. The method for manufacturing the magnet with colorable surface as claimed in claim 1, wherein the colorable facial layer is painted or sprayed on the surface of the magnet by means of a painting machine or a sprayer.

4. The method for manufacturing the magnet with colorable surface as claimed in claim 1, wherein the colorable facial layer is made of a colorable layer material which is a mixture of polymer resin, good ink-absorbing material and tackifier.

5. The method for manufacturing the magnet with colorable surface as claimed in claim 2, wherein the colorable facial layer is made of a colorable layer material which is a mixture of polymer resin, good ink-absorbing material and tackifier.

6. The method for manufacturing the magnet with colorable surface as claimed in claim 4, wherein a humidity spreader is further added into the colorable layer material.

7. The method for manufacturing the magnet with colorable surface as claimed in claim 4, wherein the polymer resin is a synthetic resin.

8. The method for manufacturing the magnet with colorable surface as claimed in claim 4, wherein the good ink-absorbing material is one of titanium dioxide, lithopone and calcium carbonate or a composition thereof.

9. The method for manufacturing the magnet with colorable surface as claimed in claim 4, wherein the tackifier is aminosilane.

10. The method for manufacturing the magnet with colorable surface as claimed in claim 6, wherein the humidity spreader is polyaminocarboxylate.

11. The method for manufacturing the magnet with colorable surface as claimed in claim 1, wherein a color layer is disposed on the colorable facial layer.

12. The method for manufacturing the magnet with colorable surface as claimed in claim 2, wherein a color layer is disposed on the colorable facial layer.

13. The method for manufacturing the magnet with colorable surface as claimed in claim 4, wherein a color layer is disposed on the colorable facial layer.

14. The method for manufacturing the magnet with colorable surface as claimed in claim 1, wherein a face of the magnet free from the colorable facial layer is coated with an adhesive layer.

15. The method for manufacturing the magnet with colorable surface as claimed in claim 2, wherein a face of the magnet free from the colorable facial layer is coated with an adhesive layer.

16. The method for manufacturing the magnet with colorable surface as claimed in claim 4, wherein a face of the magnet free from the colorable facial layer is coated with an adhesive layer.

17. The method for manufacturing the magnet with colorable surface as claimed in claim 11, wherein a face of the magnet free from the colorable facial layer is coated with an adhesive layer.

18. The method for manufacturing the magnet with colorable surface as claimed in claim 1, wherein the magnet is formed with continuously arranged tearing stripe structures.

19. The method for manufacturing the magnet with colorable surface as claimed in claim 2, wherein the magnet is formed with continuously arranged tearing stripe structures.

20. The method for manufacturing the magnet with colorable surface as claimed in claim 4, wherein the magnet is formed with continuously arranged tearing stripe structures.

21. The method for manufacturing the magnet with colorable surface as claimed in claim 11, wherein the magnet is formed with continuously arranged tearing stripe structures.

22. The method for manufacturing the magnet with colorable surface as claimed in claim 14, wherein the magnet is formed with continuously arranged tearing stripe structures.

23. The method for manufacturing the magnet with colorable surface as claimed in claim 1, wherein the magnet is cut into elongated tapes.

24. The method for manufacturing the magnet with colorable surface as claimed in claim 2, wherein the magnet is cut into elongated tapes.

25. The method for manufacturing the magnet with colorable surface as claimed in claim 4, wherein the magnet is cut into elongated tapes.

26. The method for manufacturing the magnet with colorable surface as claimed in claim 11, wherein the magnet is cut into elongated tapes.

27. The method for manufacturing the magnet with colorable surface as claimed in claim 14, wherein the magnet is cut into elongated tapes.

28. The method for manufacturing the magnet with colorable surface as claimed in claim 18, wherein the magnet is cut into elongated tapes.

29. A magnet structure with colorable surface, comprising a magnet and a colorable facial layer laid on a surface of the magnet, the colorable facial layer having high adhesion to the magnet and also having high adhesion to inks or colors.

30. The magnet structure with colorable surface as claimed in claim 29, wherein the magnet is a soft magnet.

31. The magnet structure with colorable surface as claimed in claim 29, wherein the colorable facial layer is a thin film made of a colorable layer material which is a mixture of polymer resin, good ink-absorbing material and tackifier.

32. The magnet structure with colorable surface as claimed in claim 30, wherein the colorable facial layer is a thin film made of a colorable layer material which is a mixture of polymer resin, good ink-absorbing material and tackifier.

33. The magnet structure with colorable surface as claimed in claim 31, wherein a humidity spreader is further added into the colorable layer material.

34. The magnet structure with colorable surface as claimed in claim 33, wherein the humidity spreader is polyaminocarboxylate.

35. The magnet structure with colorable surface as claimed in claim 31, wherein the polymer resin is a synthetic resin.

36. The magnet structure with colorable surface as claimed in claim 31, wherein the good ink-absorbing material is one of titanium dioxide, lithopone and calcium carbonate or a composition thereof.

37. The magnet structure with colorable surface as claimed in claim 31, wherein the tackifier is aminosilane.

38. The magnet structure with colorable surface as claimed in claim 29, wherein a color layer or figure layer is disposed on the colorable facial layer.

39. The magnet structure with colorable surface as claimed in claim 30, wherein a color layer or figure layer is disposed on the colorable facial layer.

40. The magnet structure with colorable surface as claimed in claim 31, wherein a color layer or figure layer is disposed on the colorable facial layer.

41. The magnet structure with colorable surface as claimed in claim 32, wherein a color layer or figure layer is disposed on the colorable facial layer.

42. The magnet structure with colorable surface as claimed in claim 29, wherein a face of the magnet free from the colorable facial layer is coated with an adhesive layer.

43. The magnet structure with colorable surface as claimed in claim 30, wherein a face of the magnet free from the colorable facial layer is coated with an adhesive layer.

44. The magnet structure with colorable surface as claimed in claim 31, wherein a face of the magnet free from the colorable facial layer is coated with an adhesive layer.

45. The magnet structure with colorable surface as claimed in claim 32, wherein a face of the magnet free from the colorable facial layer is coated with an adhesive layer.

46. The magnet structure with colorable surface as claimed in claim 38, wherein a face of the magnet free from the colorable facial layer is coated with an adhesive layer.

47. The magnet structure with colorable surface as claimed in claim 29, wherein the magnet is formed with continuously arranged tearing stripe structures.

48. The magnet structure with colorable surface as claimed in claim 30, wherein the magnet is formed with continuously arranged tearing stripe structures.

49. The magnet structure with colorable surface as claimed in claim 31, wherein the magnet is formed with continuously arranged tearing stripe structures.

50. The magnet structure with colorable surface as claimed in claim 32, wherein the magnet is formed with continuously arranged tearing stripe structures.

51. The magnet structure with colorable surface as claimed in claim 38, wherein the magnet is formed with continuously arranged tearing stripe structures.

52. The magnet structure with colorable surface as claimed in claim 42, wherein the magnet is formed with continuously arranged tearing stripe structures.

53. The magnet structure with colorable surface as claimed in claim 29, wherein the magnet is cut into elongated tapes.

54. The magnet structure with colorable surface as claimed in claim 30, wherein the magnet is cut into elongated tapes.

55. The magnet structure with colorable surface as claimed in claim 31, wherein the magnet is cut into elongated tapes.

56. The magnet structure with colorable surface as claimed in claim 32, wherein the magnet is cut into elongated tapes.

57. The magnet structure with colorable surface as claimed in claim 38, wherein the magnet is cut into elongated tapes.

58. The magnet structure with colorable surface as claimed in claim 42, wherein the magnet is cut into elongated tapes.

59. The magnet structure with colorable surface as claimed in claim 47, wherein the magnet is cut into elongated tapes.
